(19) United States
(12) Patent Application Publication
(10) Pub. No.: US 2011/0006137 A1
(43) Pub. Date: Jan. 13, 2011

(54) SEALED ELECTRIC FEEDTHROUGH

(76) Inventors: Holger Rapp, Ditzingen (DE); Helmut Clauss, Eberdingen (DE); Friedrich Howey, Ditzingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/933,611

(22) PCT Filed: Dec. 5, 2008
(86) PCT No.: PCT/EP08/66893

§ 371 Date: Sep. 20, 2010

(30) Foreign Application Priority Data
Mar. 19, 2008 (DE) 10-2008-000-753.6

(51) Int. Cl. F02M 51/00

(52) U.S. Cl. 239/585.1

(57) ABSTRACT

The invention relates to a fuel injector having a magnetic assembly, a magnetic core, and a magnetic coil. The magnetic assembly is accommodated in a magnetic sleeve. The magnetic sleeve is provided with feedthroughs for electric contacting pins of the magnetic coil. Elastic sealing elements are inserted into the feedthroughs of the magnetic sleeve such that a pretensioning force acting in radial direction is applied to the contacting pins of the magnetic coil in the mounted state.

### PRIOR ART

DE 196 50 865 A1 relates to a solenoid valve for controlling fuel pressure in a control chamber of an injection valve, e.g. of a common rail injection system, for supplying autoignition internal combustion engines with fuel. The fuel pressure in the control chamber is used to control a stroke motion of a valve member that opens or closes an injection opening of the injection valve. The solenoid valve includes an electromagnet, a movable armature, and a valve element that is moved with the armature, is acted on in the closing direction by a valve closing spring, and, cooperating with the valve seat of the valve element, controls the fuel discharge rate from the control chamber.

In common rail fuel injectors that are actuated by means of a solenoid valve, the electrical contacting of the solenoid coil must be routed to the outside from a chamber that is filled with fuel at the return pressure. It is usually routed through one or more bores in the magnet sleeve. One important function of this feedthrough, in addition to electrically insulating the coil and contacts in relation to the injector housing, is to hydraulically seal the feedthrough. It is therefore necessary to reliably prevent fuel from escaping to the outside via this feedthrough. In fact, the electrical contact is additionally extrusion coated with plastic at the downstream end of the feedthrough. The plastic extrusion coating and the contact tabs together constitute the electrical plug of the fuel injector. Inevitably, however, there is always a very small gap between the electrical supply line and the plastic of the extrusion coating. Because of this, fuel that emerges from the above-mentioned feedthrough also always seeps through this narrow gap into the electrical plug of the fuel injector from which it can travel to the control unit via the cable harness. This can cause damage to the control unit.

Usually, the feedthroughs are sealed with an O-ring that is slid onto the coil pins. These O-rings are first slid onto the coil pins and are then inserted from below, together with the coil pins, into the associated bore in the sleeve. As a result, they are placed under radial stress and reliably produce a seal against both the bore wall and the circumference surface of the pin. In order to prevent the O-ring from slipping through the bore, the bore is embodied so that it tapers toward the top. This can be achieved either by means of a step or by means of a conical bore shape. To make sure that the O-ring is inserted into the bore, the coil pin is extrusion coated with plastic in its lower region, forming a so-called “dome” above the extrusion coating of the coil, thus also preventing the coil pin from touching the magnet core.

Since the magnet core usually rests on a shoulder in the sleeve, the sleeve has up till now been embodied of two parts, i.e. an actual sleeve and an outlet fitting. The magnet core with the coil was first inserted into the sleeve from above until it came to rest on its shoulder. Then, the outlet fitting was set into place on top and held down with a definite force. The outlet fitting and sleeve were then flanged to each other, thus fixing the magnet in its position. The feedthroughs of the coil pins in this case were produced in the outlet fitting. If the sleeve is inexpensively embodied of one piece, then as a result, the magnet core must be inserted into the sleeve from below. In this connection, it is particularly advantageous if the inner contour of the sleeve and the outer contour of the core are not embodied as rotationally symmetrical, but instead have a radial contour. First, the core is inserted into the sleeve from below in an angular position in which the sleeve and core do not coincide with each other when viewed from below. Between the core and sleeve, there is a spring element that is over-compressed by exerting a definite installation force. If the magnet core is inserted into the magnet sleeve far enough that its end surface is situated above the associated support surface in the sleeve, then the core is twisted by a definite angle (e.g. 45°) relative to the sleeve. This brings the regions with the large outer diameter of the core into interaction with the regions with the small inner diameter of the support surface. Upon release of the installation pressure, these regions rest against each other so that the core is now fixed in place in the sleeve.

Since the magnet core is twisted during installation, it is not yet possible for the solenoid coil to be installed in the magnet core; instead, it can be inserted into the magnet core from below only after the latter has been installed and aligned. Since the outer diameter of the O-rings is larger than the recess for the pin dome in the magnet core, the solenoid coil can only be installed without O-rings. Alternatively, it is possible not to seal the feedthroughs with O-rings, but instead to fill these feedthroughs with glue after installation of the complete magnet assembly, thus sealing them. But this variant involves some risks that must be viewed as critical with regard to the fault sequence, for example the escape of fuel to the outside: when it is in the liquid state, the glue does in fact initially fill the entire space between the sleeve and pin, but then it hardens. If a subsequent warping occurs in the joined components, whether due to the action of external forces (screws, magnet head, securing elements, etc.) or due to differing thermal expansions, then the originally sealed connection between the glue plug and the magnet sleeve or the pin may be lost again, allowing that leakage gaps for the fuel to form again. The glue plug is also continuously exposed to the fuel, sometimes at high temperatures. It is therefore necessary, given the occurrence of changing fuel qualities, to assure the chemical resistance of the glue to the fuel for periods of up to 15 years. Because of the above-mentioned risks, using glue to seal pins is risky.

### DEPICTION OF THE INVENTION

By means of the proposed invention, it is possible to achieve a reliably functioning sealing of feedthroughs of electrical contacting pins from the housing of the fuel injector, without having to resort to a glue variant that entails the risks explained above. The invention proposes introducing a sealing element similar to an O-ring into the pin feedthrough, which, by contrast with O-rings previously inserted into the pin feedthrough, permits a subsequent installation of the solenoid coil. An installation of O-rings that are simply introduced into the feedthrough bores in advance differs in that without the spreading by means of the contacting pin of the solenoid coil, the O-rings are deformed in skew fashion in the feedthrough bore so that it is not possible to guarantee either a reliably sealing function or a reliable installability of the solenoid coil.

The invention proposes vulcanizing a sealing element composed of elastic material into the feedthrough bore for the contacting pin for electrically contacting the solenoid coil. This already assures the seal in relation to the magnet sleeve. The inner diameter of the sealing element vulcanized in place is smaller than the diameter of the contacting pin for electrically contacting the solenoid coil. If the solenoid coil is then installed from below, the contacting pins for electrically contacting the solenoid coil are slid through these openings of the sealing elements that have been vulcanized in place in advance. As a result, these sealing elements are prestressed in the radial direction by the inserted contacting pins, thus also sealing the contacting pins toward the outside. This radially extending prestressing action in and of itself also produces a seal of the contacting pins guided outward through the magnet sleeve so that the seal is assured even if the connection produced on the molecular level between the sealing element and the magnet sleeve surface wears off over time. Possible causes for this may be temperature changes and mechanical stresses that occur. The seal is assured by the radial prestressing of the sealing element that has been vulcanized in place and not—as with introduced glue—solely by the chemical bond between the surfaces of the sealing element and the surfaces of the magnet sleeve and contacting pins. As a result, the reliable seal is achieved over the entire product life.

In an advantageous embodiment variant of the concept underlying the invention, the sealing elements that are vulcanized in place can be embodied not with a small internal opening, but instead as penetrable. In this case, the thickness at the center is less than the thickness at the outside and the sealing elements are embodied so that the contacting pin of the solenoid coil can pierce the sealing element there with the exertion of a slight axial force. During installation of the solenoid coil, the sealing elements are pierced at these thin locations and as a result, are prestressed in the radial direction so that they likewise produce a seal in relation to the electrical contacting pins of the solenoid coil.

The embodiment proposed according to the invention will be described below in conjunction with a fuel injector for actuation by means of a solenoid valve for use in a high-pressure accumulator injection system (common, rail), but can also be used in other motor vehicle components in which it is imperative to prevent a medium from escaping to the outside.

### BRIEF DESCRIPTION OF THE DRAWINGS

The invention will be described in detail below in conjunction with the drawings.

FIG. 1 shows a cross section through a magnet head of a solenoid valve for a fuel injector, with a sealing of a contacting pin by means of an O-ring and an injected glue element,

FIG. 2 is a bottom view of a magnet head with a one-piece sleeve and a magnet core that is twisted-locked in place,

FIG. 3.1 shows a sealing element that is vulcanized in place as a separate component,

FIG. 3.2 shows a sealing element that is vulcanized in place, after installation of the solenoid coil,

FIG. 4.1 shows a sealing element that is vulcanized in place and has no internal opening, as a separate component, and

FIG. 4.2 shows a sealing element that is vulcanized in place, after installation of the coil.

### EMBODIMENTS OF THE INVENTION

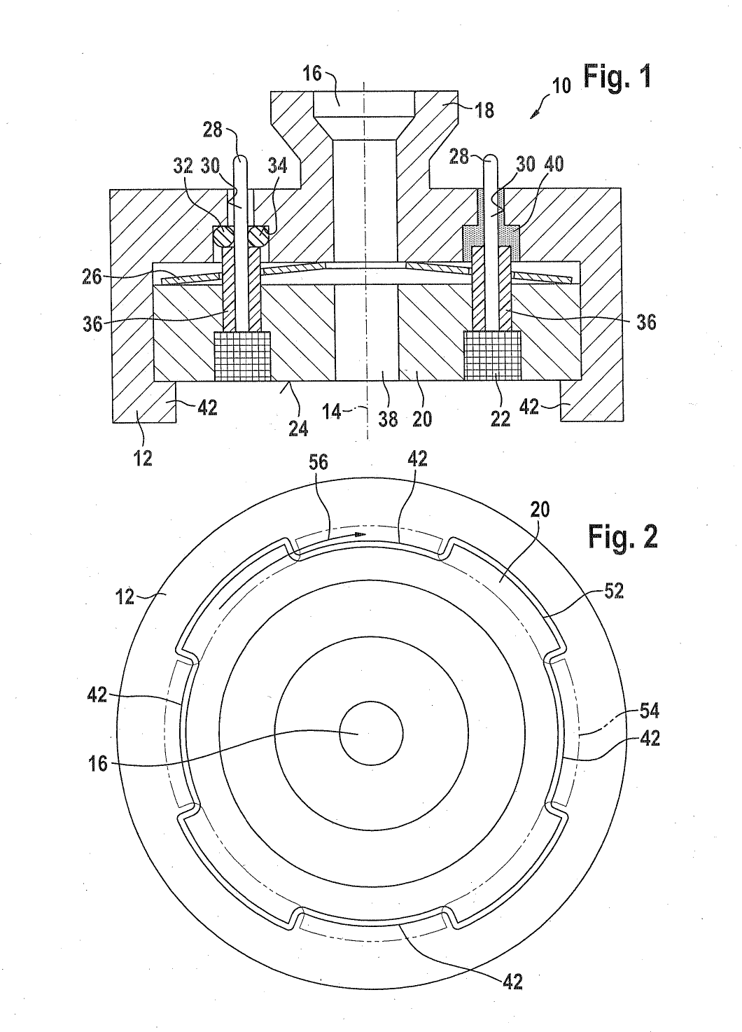

The depiction in FIG. 1 shows a solenoid assembly that includes a solenoid coil and is sealed in relation to the outside in two different ways to prevent the escape of fuel from a fuel injector.

FIG. 1 shows a sectional view of a solenoid assembly 10 accommodated in a magnet sleeve 12, which is embodied of one piece in this case. The magnet sleeve 12 and the solenoid assembly 10 are embodied as symmetrical to an injector axis 14 of a fuel injector that is not shown in FIG. 1. The solenoid assembly 10 actuates the fuel injector, i.e. relieves a pressure in a control chamber under system pressure.

The magnet sleeve 12 has a return 16 that is aligned with a return connection 18 on the outside of the circumference surface 12.

The solenoid assembly 10 essentially includes a magnet core 20 and a solenoid coil 22 embedded in the magnet core 20. An end surface of the magnet core 20 oriented toward an armature assembly not shown in FIG. 1 is labeled with the reference numeral 24 in the depiction according to FIG. 1.

As is also shown in the depiction according to FIG. 1, the solenoid coil 22 of the solenoid assembly 10 is electrically connected via a contacting pin 28. The contacting pin 28—as shown in the left half of FIG. 1—can be sealed by means of an O-ring 32. The O-ring 32 is inserted into a feedthrough 30 and is placed against a shoulder of the magnet sleeve 12 by means of a plastic dome 36. This embodiment, however, requires the solenoid coil 22 to be moved only in the axial direction during installation in the magnet head and requires the O-rings 32 to be already preinstalled on the coil pins.

In the exemplary embodiment shown in the right half of FIG. 1, the contacting pin 28 for supplying power to the solenoid coil 22 is sealed inside the magnet core 20 by means of a glue plug 40. As long as the glue in the feedthrough 30 is able to flow, it penetrates into all of the pores and small gaps of the magnet sleeve 12 and seals them in relation to the outside of the magnet sleeve 12. As soon as the material of the glue plug 40 has hardened, however, mechanical stresses and temperature-induced expansions can cause microcracks that permit fuel to escape from the low-pressure region 38 to the outside of the solenoid assembly 10. It is in fact possible for the glue plug 40 to produce a seal as shown in FIG. 1, but there is a not insignificant risk of the sealing action being lost in the course of the life of the product.

The depiction according to FIG. 2 shows a view of a solenoid assembly 10 from below.

As shown in FIG. 2, the magnet sleeve 12—see the depiction according to FIG. 1—includes a number of overlap tabs 42 along a circumference of an installation opening. These overlap tabs 42 are embodied in the radial direction so that they exceed the diameter of a magnet core 20 to be installed. The magnet core 20, which is, however, to be inserted into the magnet sleeve 12 from below and then twisted in a twisting direction 56, has a number of wing-shaped widenings on its outside. These wing-shaped widenings are slid into the magnet sleeve 12 in a first angular position 52 of the magnet core 20 relative to the magnet sleeve 12. The insertion of the magnet core 20 into the magnet sleeve 12 is followed by a twisting 56 of the magnet core 20 in a clockwise direction 56, which causes the wing-shaped projections on the circumference of the magnet core 20 to coincide with overlapping elements 42 (see depiction in FIG. 1) of the magnet sleeve 12. The action of the spring element 26 embodied in the form of a disk spring presses the magnet core 20—without the solenoid coil 22—against the radial projections of the magnet sleeve 12.

After installation of the magnet core 22 as shown in FIG. 2, the solenoid coil 22 is inserted from below. The solenoid coil 22 is equipped with the contacting pins 28 to be electrically contacted, which extend through the feedthroughs 30—see the depiction in FIG. 1—and are electrically contacted on the outside of the magnet sleeve 12 of the solenoid assembly 10. Preferably, the electrical contacting of the contacting pins 28 is produced using pin terminals that are welded or soldered to the contacting pins 28 or connected to them in another electrically conductive fashion. In this embodiment, it would only be possible to produce a seal using O-rings 32 if the magnet core 20 had through openings in that were larger than the outer diameter of the O-ring 32 mounted on a coil pin 28. Such large openings in the magnet core 20, however, are counterproductive to achieving the desired magnetic force and are therefore to be avoided where possible.

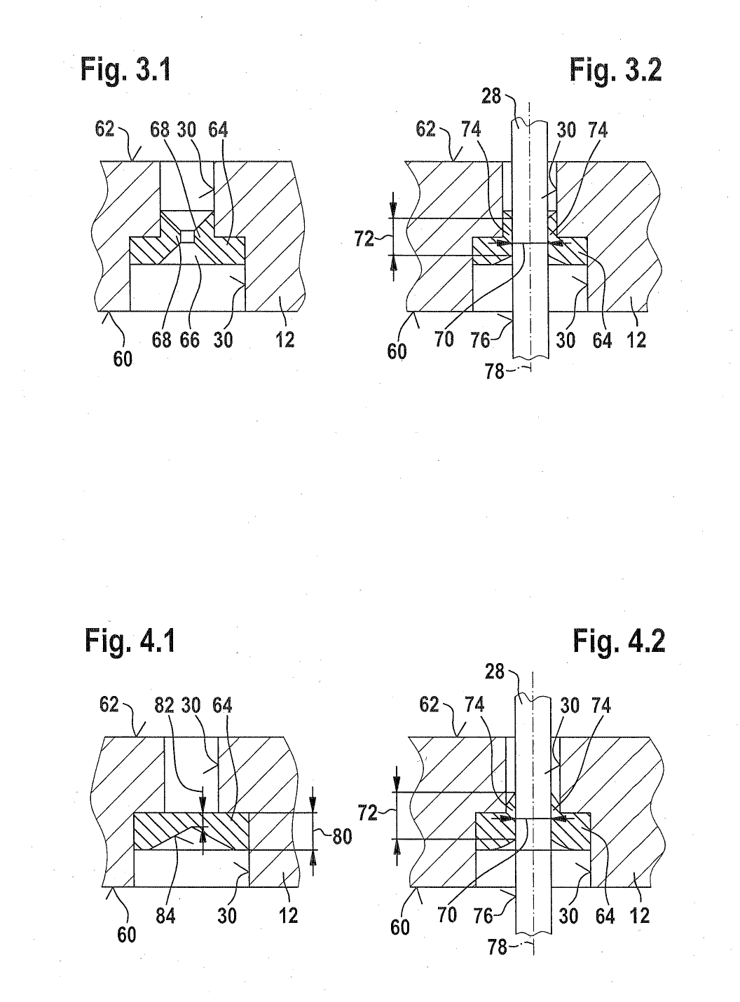

The depiction in FIG. 3.1 shows a first embodiment of the elastic sealing element proposed according to the invention.

As shown in FIG. 3.1, a sealing element 34 that has been vulcanized in place is accommodated in the magnet sleeve 12 in the vicinity of the feedthrough 30. The sealing element 64 that has been vulcanized in place is preferably vulcanized in place in a diameter transition in the feedthrough 30, against the shoulder produced by the diameter transition, and is fixed in position inside the feedthrough 30 in this way.

An outside of the magnet sleeve 12 is labeled with the reference numeral 62, while an inside 60, i.e. the side of the magnet sleeve 12 oriented toward the low-pressure region 38, is labeled with the reference numeral 60. As shown by FIG. 3.1, the sealing element 64 vulcanized in place in the feedthrough 30 has an internal opening 66. The inner diameter of the internal opening 66 is smaller than the outer diameter of the contacting pin 28 via which the solenoid coil 22 of the solenoid assembly 10 is electrically contacted after installation in the magnet sleeve 12. The sealing element 64 that is vulcanized in place in the diameter transition of the feedthrough 30 in the depiction in FIG. 3.1 includes sealing lips 68 that fit snugly against the circumference surface 36 of the contacting pin 28 after it is installed. The diameter difference between the internal opening 66 of the sealing element 64 vulcanized in place in the feedthrough 30 relative to the outer diameter of the contacting pin 28 produces a radial prestressing 70 of the material of the sealing element 64 vulcanized in place in the feedthrough 30.

The depiction according to FIG. 3.2 shows the sealing element that is vulcanized in place, with a contacting pin in the installed position.

As shown in FIG. 3.2, the installation of the contacting pin 28 of the solenoid coil 22 causes a stretching of the internal opening 66 of the sealing element 64 vulcanized in place in the feedthrough 30. The inner diameter of the sealing element 64 vulcanized in place is smaller than the outer diameter of the contacting pin 28 of the solenoid coil 22. Consequently, when the contacting pin 28 is inserted into the sealing element 64 vulcanized in place in the feedthrough 30, this deflects the sealing lips 68 of the sealing element in the radial direction, which exerts a radial prestressing 70 in the radial direction inside a sealing length 72. The sealing length 72 that is produced when the contacting pin 28 is inserted into the sealing element 64 that is vulcanized in place in the magnet sleeve 12 is essentially the same size as the diameter of the sealing element 64 vulcanized in place.

As also shown in FIG. 3.2, the sealing element 64 vulcanized in place in the feedthrough 30 rests against a shoulder defined by a diameter change in the feedthrough 30 and is therefore secured in the axial direction—relative to the insertion direction of the contacting pin 28—and positioned in the defined location. If the contacting pins 28 are slid into the sealing element 64 that is vulcanized in place in the magnet sleeve 12, the sealing lips 68 are stretched radially so that they fit snugly against the circumference surface 76 of the contacting pin 28 of the solenoid coil 22 along a sealing length 72. Depending on the length of the sealing length 72, this produces a seal of the low-pressure region 38, shown in FIG. 1, of a fuel injector. The reference numeral 60 refers to the inside of the magnet sleeve 12, i.e. the region that is filled with fuel at low pressure, and the reference numeral 62 refers to an outside of the magnet sleeve 12. It is imperative to prevent fuel in the low-pressure region 38 from escaping to the outside. According to the depiction in FIG. 3.2, the contacting pin 28 is embodied as symmetrical to the axis 78 of the contacting pin 28. The reference numeral 74 refers to the sealing lips 68 of the sealing element 12 that is vulcanized in place in the magnet sleeve 12 in the deformed state, i.e. when placed against the circumference surface 76 of the contacting pin 28.

FIGS. 4.1 and 4.2 show an embodiment variant, proposed according to the invention, of the sealing element that is vulcanized in place.

The sealing element 64, shown in FIGS. 4.1 and 4.2, that is vulcanized in place in the magnet sleeve 12 differs from the embodiment variant according to FIGS. 3.1 and 3.2 in that it is embodied with a first thickness 80 and a second, reduced thickness 82. It is also clear from the depiction in FIG. 4.1 that the sealing element 64 that is vulcanized in place in the magnet sleeve 12 has a funnel-shaped insertion bevel 84. While the center of the essentially rotationally symmetrical sealing element 64 that is vulcanized in place has the second, reduced thickness 82, according to the embodiments shown in FIGS. 4.1 and 4.2, the sealing element that is vulcanized in place has the first thickness 80 in the region in which it rests in a diameter change of the feedthrough 30 of the magnet sleeve 12. The first thickness 80 is at least twice as great as the second, reduced thickness 82 of the sealing element 64 that is vulcanized in place.

During installation of the solenoid coil 22 into the magnet core 20, the insertion bevel 84, which is situated on the side of the sealing element 64 vulcanized in place in the magnet sleeve 12 oriented toward the contacting pin 28 of the solenoid coil 22, guides the tip of the contacting pin 28 toward the center of the region of the second thickness 82, which is reduced in comparison to the first thickness 80. Through exertion of a slight axial force, the tip of the contacting pin 28 pierces the sealing element 64, which is vulcanized in place in the magnet sleeve 12, in the region of the second, reduced thickness 82 inside the insertion bevel 84.

FIG. 4.2 shows the installed state of the contacting pin.

As a result of the installation—i.e. the axial piercing of the sealing element 64, which is vulcanized in place in the magnet sleeve 12, in the region of the second, reduced thickness 82 and the insertion bevel 84—the sealing lips 68 separated from each other by the tip of the contacting pin 28 and by its circumference surface 26, fit snugly in the compressed state 74 against the circumference surface 76 of the contacting pin 28 and produce the seal of the low-pressure region 38 of a fuel injector. The depiction in FIG. 4.2 also shows that the deflection of the sealing lips 68 and the transition into a compressed state 74 produce a sealing length 72 in the axial direction relative to the contacting pins 28, effectively sealing off the low-pressure region 38 below the armature-side end surface 24 of the solenoid assembly 10 from the outside 62 of the magnet sleeve 12. The vulcanization in place of the sealing element 64 assures it of being seated in a stationary fashion; this type of attachment in the shoulder of the feedthrough 30 in the magnet sleeve 12 does not impair the elastic deforming properties of the material of the sealing element 64 that is vulcanized in place.

The depiction in FIG. 4.2 shows the sealing lips 68 in the compressed state 74, i.e. in the deflected state, resting against the circumference surface 76 of the contacting pin 28 along the sealing length 72.

The above-described embodiment for sealing contacting pins 28 can also be transferred to the sealing of other electrical supply lines, e.g. supply lines of piezoelectric actuators or sensors.

1-11. (canceled)

12. A fuel injector equipped with a solenoid assembly including a magnet core and a solenoid coil, with the solenoid assembly accommodated in a magnet sleeve that has feedthroughs for electrical contacting pins of the solenoid coil, wherein elastic sealing elements are vulcanized in place in the feedthroughs in such a way that contacting pins of the solenoid coil are acted on by a radial prestressing force to produce a seal in an installed state of the sealing elements in the feedthroughs of the magnet sleeve.

13. The fuel injector as recited in claim 12, wherein the elastic sealing elements are vulcanized in place at a shoulder embodied at a change in an inner diameter of the feedthroughs.

14. The fuel injector as recited in claim 12, wherein the elastic sealing elements are embodied as rotationally symmetrical and have sealing lips that rest against a circumference surface of contacting pins in an installed state of the contacting pins.

15. The fuel injector as recited in claim 13, wherein the elastic sealing elements are embodied as rotationally symmetrical and have sealing lips that rest against a circumference surface of contacting pins in an installed state of the contacting pins.

16. The fuel injector as recited in claim 14, wherein when deflected by the contacting pins, the sealing lips rest against the circumference surface of the contacting pins along a sealing length and seal the feedthroughs of the magnet sleeve.

17. The fuel injector as recited in claim 15, wherein when deflected by the contacting pins, the sealing lips rest against the circumference surface of the contacting pins along a sealing length and seal the feedthroughs of the magnet sleeve.

18. The fuel injector as recited in claim 12, wherein the sealing elements have an internal opening embodied with a diameter that is smaller than an outer diameter of the contacting pins.

19. The fuel injector as recited in claim 12, wherein the sealing elements are embodied with a first thickness and with a second, reduced thickness at their centers.

20. The fuel injector as recited in claim 19, wherein in a region of the second, reduced thickness, the sealing elements have an insertion bevel that is pierced by the contacting pins as the sealing elements are installed in the magnet sleeve.

21. The fuel injector as recited in claim 16, wherein the sealing length essentially corresponds to a diameter of the sealing element.

22. The fuel injector as recited in claim 17, wherein the sealing length essentially corresponds to a diameter of the sealing element.

23. The fuel injector as recited in claim 12, wherein viewed in a piercing direction of the contacting pins, the sealing elements rest against a shoulder of the feedthroughs in the magnet sleeve.

24. The fuel injector as recited in claim 12, wherein in the installed state, the magnet core in the magnet sleeve is moved into a second angular position and is pushed against radial projections of the magnet sleeve by means of a spring element.

25. A use of elastic sealing elements in a fuel injector according to claim 12, for sealing electrical supply lines of piezoelectric actuators and sensors.
